(19) United States
(12) Patent Application Publication
(10) Pub. No.: US 2002/0120421 A1
(43) Pub. Date: Aug. 29, 2002

(54) Controller having internal durability test cycle driver

(76) Inventors: Daniel A. Crawford, Burton, MI (US); Joyce D. Carsey, Swartz Creek, MI (US)

Correspondence Address: VINCENT A. CICHOSZ, DELPHI TECHNOLOGIES, INC., Legal Staff Mail Code: 480-414-420, P.O. Box 5052, Troy, MI, 48007-5052, US

(21) Appl. No.: 09/906,315

(22) Filed: Jul. 16, 2001

Related U.S. Application Data
(60) Provisional application No. 60/271,976, filed on Feb. 27, 2001.

(51) Int. Cl. G06F 19/00

(52) U.S. Cl. 702/122

(57) ABSTRACT

An exemplary embodiment of the invention is an actuator assembly having a controller integrated into the actuator assembly. The controller includes a memory for storing test cycle data and a processor in communication with the memory. The processor accesses the test cycle data. A communication port is in communication with the processor and in communication with an actuator and a sensor. During a test mode, the processor provides position commands to the actuator and receives a sensor signal from the sensor. The processor detects the presence of faults in response to the sensor signal and stores the faults in the memory.

### CROSS-REFERENCE TO RELATED APPLICATIONS

This application claims the benefit of U.S. provisional patent application serial No. 60/271,976 filed Feb. 27, 2001, the entire contents of which are incorporated herein by reference.

### BACKGROUND

Micro-processor controlled actuators are used in a variety of applications such as heavy-duty diesel trucks for use in turbo-charger and emission control systems. These Remote Smart Actuators (RSA's) integrate a microprocessor-based electronic controller into a brushless motor/geartrain/output shaft mechanism. The primary function of the RSA is to position its output shaft quickly and accurately as commanded by the vehicle's Engine Control Module (ECM). This action is then translated via linkage to the appropriate system component.

The requested durability of RSA's (while subjected to a severe in-application temperature/vibration environment) is in the range of 500,000 to 1,000,000 miles. Significant probe and validation testing is required by the customer to demonstrate this capability. Traditional testing techniques utilize a PC-based test system to command several RSA's to follow a specified actuation or “usage” profile for each specific test environment and to then log both cycle count and any anomalies or apparent faults seen on any RSA. Several loops are typically run simultaneously to minimize overall test time. A different PC-based test system would be utilized for each specific test loop. These test systems will ultimately need replacement due to ordinary wear and tear.

### SUMMARY

An exemplary embodiment of the invention is an actuator assembly having a controller integrated into the actuator assembly. The controller includes a memory for storing test cycle data and a processor in communication with the memory. The processor accesses the test cycle data. A communication port is in communication with the processor and in communication with an actuator and a sensor. During a test mode, the processor provides position commands to the actuator and receives a sensor signal from the sensor. The processor detects the presence of faults in response to the sensor signal and stores the faults in the memory.

The above described and other features are exemplified by the following figures and detailed description.

### BRIEF DESCRIPTION OF THE DRAWINGS

Referring now to the Figures, which are meant to be exemplary and not limiting, and wherein like elements are numbered alike in the figures:

FIG. 1 is a simplified block diagram of an actuator assembly;

FIG. 2 is a flowchart of a failsafe process to enable an internal test mode;

FIG. 3 is a flowchart of a process for accessing cycle information when the internal test mode is enabled;

FIG. 4 depicts exemplary test profile byte definitions; and,

FIGS. 5a and 5b depict two exemplary test cycle data tables.

### DESCRIPTION OF THE PREFERRED EMBODIMENT

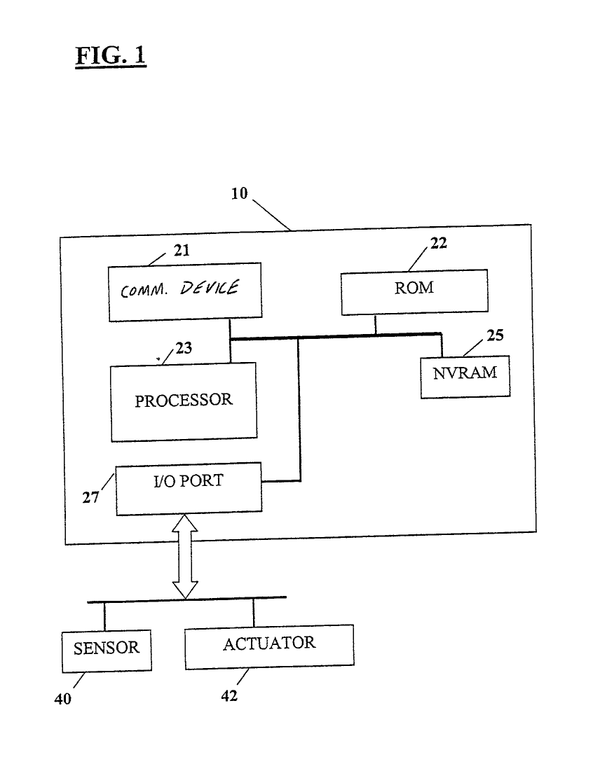

An exemplary embodiment of the invention integrates a durability test cycle driver into the program memory of an embedded controller on an actuator. FIG. 1 is a block diagram of an actuator assembly. An embedded controller 10 is integrated onto a printed wiring board (PWB) of the actuator assembly. The controller 10 includes a processor 23 which may be implemented using existing microprocessors. A communications device 21 provides for communication with a master controller (e.g. a vehicle ECM). Communications device 21 may be a universal asynchronous receiver/transmitter (UART) or any other device providing serial communications. Read only memory (ROM) 22 may be a non-volatile memory containing computer programs used to initialize processor 23. Nonvolatile random access memory (NVRAM) 25 may be used to store program instructions executed by processor, test cycle data and test results. An I/O port 27 (e.g., a serial port) may send control signals to actuators 42 and receive sensor signals from sensors 40 via a controller area network (CAN). The actuator may be an electric motor and the sensor a Hall-effect sensor that detects motor position. In this way, the actual motor position can be compared to commanded position. Discrepancies between the commanded motor position and sensed motor position indicate a fault. The processor 23 detects faults and stores a record of an occurrence of a fault in NVRAM 25. Additional supporting components (e.g., power supply, resistors, capacitors, etc.) may be included in the controller as known in the art.

If controller 10 enters an internal test mode while the normal application (e.g., normal actuator control) is running, an error is likely. Therefore, the logic for enabling the internal test mode must ensure that a single point failure will not inadvertently enable the test mode. Controller 10 executes a failsafe process to prevent inadvertently entering test mode.

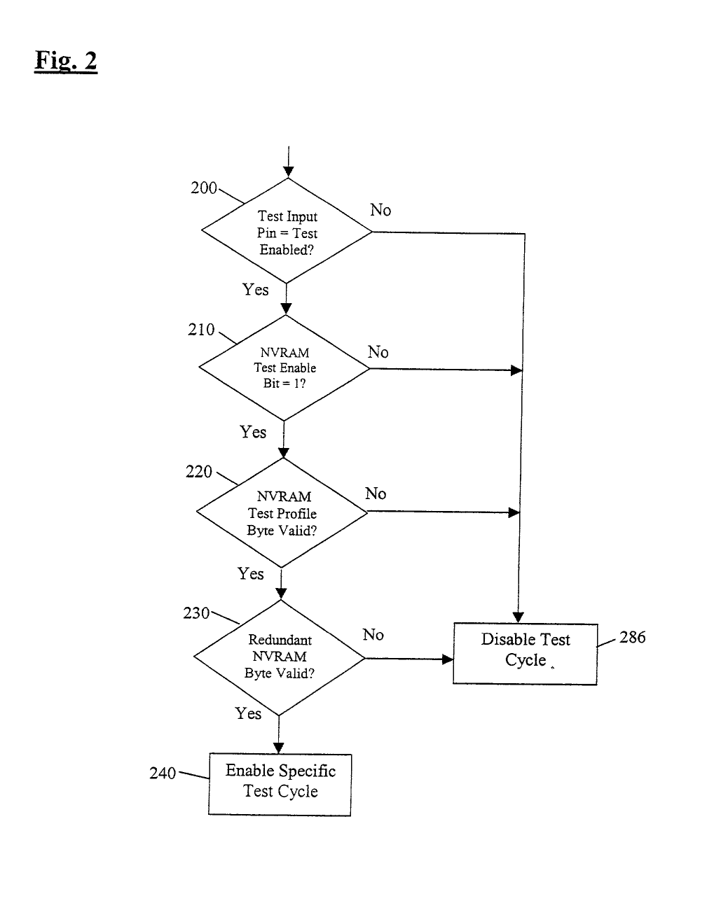

FIG. 2 depicts a flowchart of a failsafe mechanism that prevents inadvertent launch of test mode by requiring a test profile byte to be written at redundant nonvolatile memory addresses for an internal test mode to be engaged. Additionally, by requiring simultaneous controller 10 external pin selections along with the previously mentioned NVRAM selections, a further failsafe can be provided.

FIG. 2 demonstrates the procedure for enabling/disabling the internal test mode. Initially, the processor 23 determines whether the proper external pin (or pins) on processor 23, referred to as the test input pin, has been selected at step 200. An exemplary embodiment grounds the appropriate pin to perform such a selection. If the test input pin is not enabled, the test cycle is disabled at step 286. If the test input pin is enabled, the procedure will then check whether the NVRAM 25 has been enabled at step 210. This may be confirmed by checking whether the NVRAM test enable bit is set to “1”. As with step 200, a negative response will disable the test cycle at step 286.

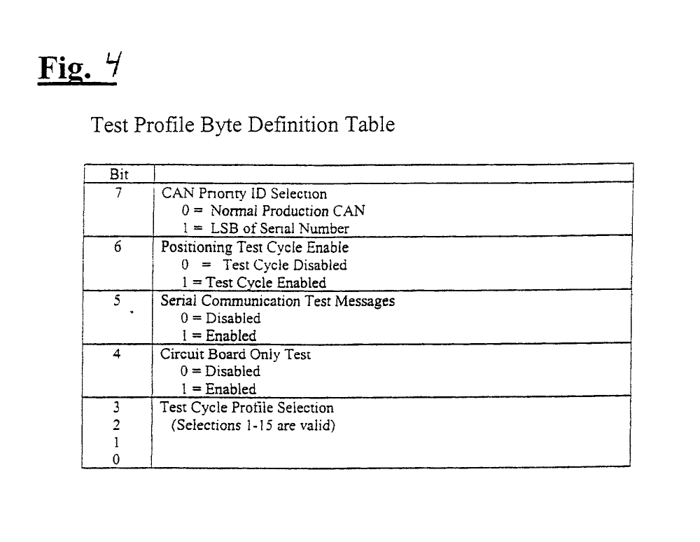

If the NVRAM test bit is enabled, flow proceeds to step 220, which involves checking the NVRAM test profile byte. Values for bits in the test profile byte are depicted in FIG. 4. As shown in FIG. 4 and described in further detail herein, the test profile byte specifies a particular test mode through bits 4-7 and selects test cycle data through bits 0-3. The test profile byte may be tested by checking the status of bites 4-7. For example, bit 4 (circuit board only) and bit 6 (positioning test cycle) cannot both be enabled.

If the test profile byte is invalid, the test cycle is disabled at step 286. Otherwise, the procedure checks for the proper redundant NVRAM test profile byte at 230. As before, an improper value for the redundant NVRAM test profile byte will terminate the internal test cycle at step 286, otherwise flow proceeds to step 240 where test cycle is enabled. Setting the test input pin, the NVRAM test bit, the NVRAM test profile byte and the redundant NVRAM test profile byte may be performed by a master controller communicating with controller 10 through communications device 21.

To further protect against inadvertently enabling an internal test mode during normal operation, the test enabling data may be checked at least once every 3 milliseconds. An erroneous value in the NVRAM test bit at 210, NVRAM test profile byte at 220 or the redundant NVRAM profile byte at 230 will cause the internal test mode to be disabled and the controller 10 will return to normal operation. The NVRAM is updated to disable the test cycle in subsequent ignition cycles.

The internal test has several distinct test modes as described below, which can be enabled individually or simultaneously. The modes include a command position mode, CAN communication ID mode, printed wiring board mode and serial communications mode.

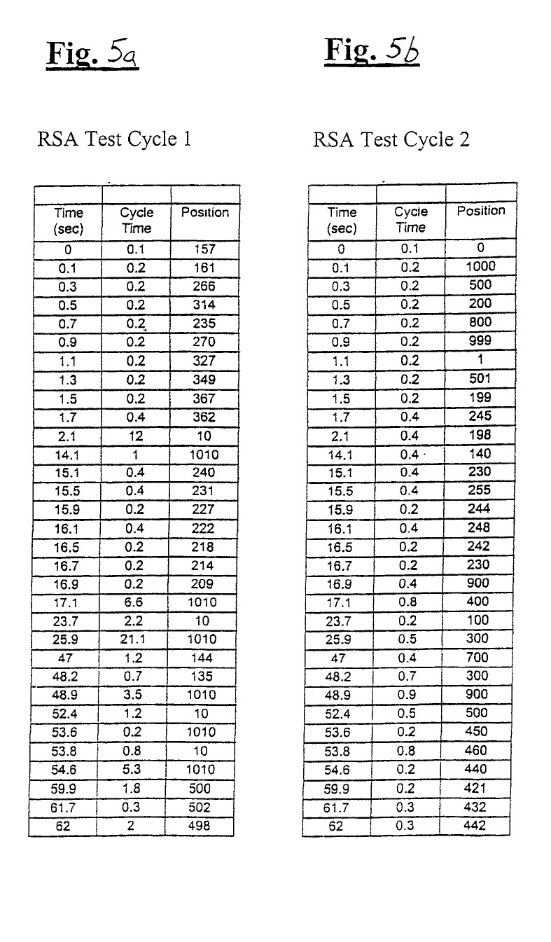

In the command position test mode, the processor 23 extracts an actuator position and time at that position from a table stored in ROM and controls an actuator based on the retrieved position and time. FIGS. 5a and 5b demonstrate such tables. As indicated in FIG. 4, bits 0-3 of the test profile byte define the table selected. So for example, if the test profile byte were designated to select table 2, the values from FIG. 5b would be used. These tables assume a base cycle time of 100 milliseconds. For flexibility, the base cycle time is stored in NVRAM, but may be modified at any time via communications device 21. The test cycle table defines the desired actuator position (0 to 100%) and time at that position in 100 ms units. The position values represent a position within the actuator's range of motion. A cycle counter is stored in NVRAM 25 and is updated each time the test table cycle is completed.

The controller area network (CAN) ID test mode allows a test monitoring system to communicate with and distinguish between multiple parts on the same CAN bus. The part serial numbers are stored in NVRAM and read into the controller 10 on power up. In the preferred embodiment, the most significant bit (MSB) of the priority ID for a part is substituted with the least significant bit (LSB) of the part's serial number. This allows each part coupled to CAN to be identified during this test cycle. When testing multiple parts at the same time, this mode may be used to detect which part or parts have returned a fault.

The printed wiring board (PWB) test mode simulates sensor inputs (e.g., hall-effect sensors, position sensors) to controller 10. The processor 23 extracts simulated sensor values from a table in NVRAM 25 that may be copied from ROM 22 or received through communications device 21. Thus, instead of using input information from sensors coupled to I/O port 27, predefined or previously recorded values are used. This allows the internal parameters of the PWB to be tested without an actuator.

The serial communications mode, while not a true test cycle, allows the controller to receive serial communication protocols that are not part of its normal applications. During this mode, test specific parameters and/or fault data are transmitted in periodic messages to controller 10. This mode may be used outside of normal operation during events such as a bum-in test of the actuator assembly. The controller can monitor test specific parameters and/or fault data while the actuator is being tested outside of normal operation.

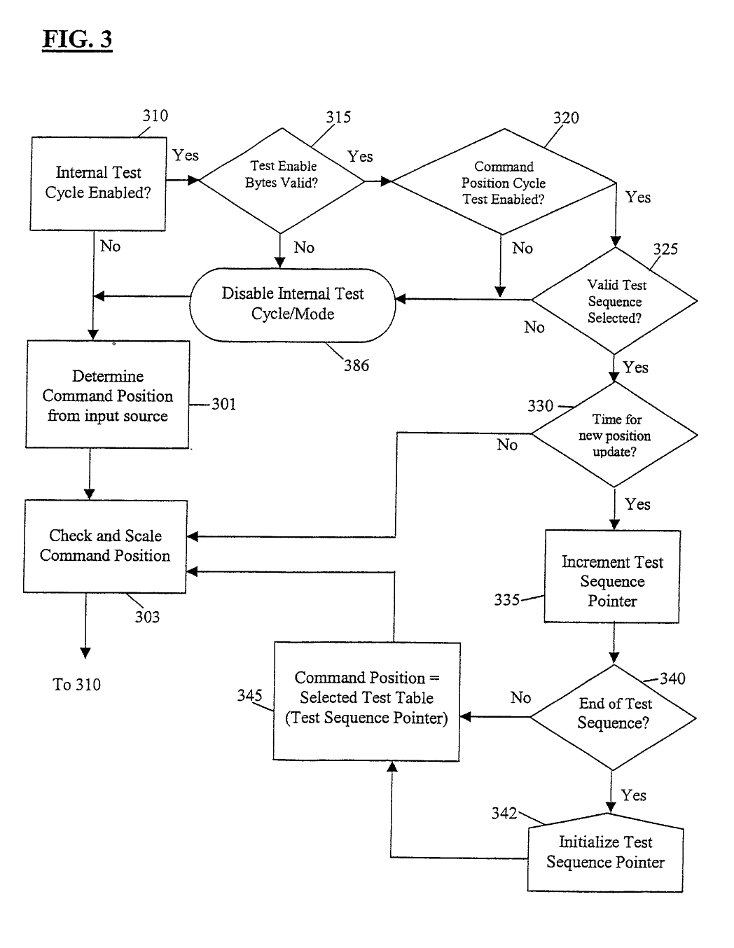

FIG. 3 is a flowchart of the processing performed by controller 10 when in command position mode. This mode is used to cycle actuators through positions to detect faults. The process begins at step 310 where it is determined whether the controller 10 is actually in command position mode. This may be done by verifying the internal test enable bit is enabled as shown in step 210 of FIG. 2. If the controller has exited test mode, flow proceeds to steps 301 and 303. At step 301, the commanded actuator position is determined. Typically, a command signal is generated by a master controller (e.g., ECM) which dictates the position of an actuator. At step 303, the commanded position is checked (e.g., to determine if actuator limits are exceeded) and scaled accordingly using known techniques. The commanded position signal is then provided to the actuator.

If the test cycle has been enabled, the test enable byte and redundant test enable byte are checked for validity at 315 as a failsafe. If either the test enable byte or the redundant test enable byte is invalid, the internal test cycle will be disabled at step 386. If the internal test enable bit is set to 1 prior to loading the test profile byte or redundant test profile byte correctly, these bytes are cleared and the procedure reinitiated. The next check is performed at step 320 where it is determined whether the command position mode has been enabled. This may be determined by checking bit 6 of the test profile byte as shown in FIG. 4. If not, the internal test cycle will be disabled at step 386.

If the command position cycle is enabled then the processor determines whether a valid table was selected at 325. Bits 0-3 of the test profile byte designate a table to be used to cycle the actuator through positions. Each table represents a sequence (the two tables shown in FIGS. 5a and 5b are examples of only two tables), but if a value is designed for a table that does not exist (e.g., in NVRAM), the internal test mode will be disabled at 386. If a valid table is selected, then an internal clock is compared to the table at 330 to determine whether it is time to alter the position of the actuator. As shown, for example, in FIG. 5b, the table includes time and position values. Referring to FIG. 5b, the test cycle begins with the actuator at position 0 for 0.1 seconds and then moves the actuator to position 1000 for 0.2 seconds and so on.

If at step 330 it is not time for a position change, the process loops through steps 303 and 310. If it is time for a new position update, a test cycle pointer is incremented by one at step 335. The test cycle pointer references the current step of the test cycle defined by the table. The processor then checks to make sure it is not at the end of the table at step 340. If it is, the processor resets the sequence pointer at step 342 by starting all over again at the beginning of the selected table. At step 345, either the current intermediate table value or the reinitialized table value is used for the command position for the actuator. This command position is checked and scaled at step 303 and applied to the actuator. In order to terminate the test procedure, a motor off commanded may be transmitted through communications device 21 to override the internal test and turn outputs to the actuator off.

While preferred embodiments have been shown and described, various modifications and substitutions may be made thereto without departing from the spirit and scope of the invention.

What is claimed is:

1. An actuator assembly comprising:
a controller integrated into said actuator assembly, said controller including:
memory storing test cycle data;
a processor in communication with said memory, said processor accessing said test cycle data;
a communication port in communication with said processor and in communication with an actuator and a sensor;
wherein during a test mode, said processor provides position commands to said actuator and receives a sensor signal from said sensor,
said processor detecting faults in response to said sensor signal and storing faults in said memory.

2. The actuator assembly of claim 1, wherein said memory comprises non-volatile random access memory.

3. The actuator assembly of claim 1, wherein said test cycle data defines a commanded actuator position and said sensor signal provides a measured actuator position, said faults being indicative of a difference between said commanded actuator position and said measured actuator position.

4. The actuator assembly of claim 1, wherein said test cycle data includes command position data and time data.

5. The actuator assembly of claim 1, wherein said communication port is in communication with said sensor and said actuator over a controller area network.

6. The actuator assembly of claim 1, further comprising a communications device for communicating with a master controller.

7. The actuator assembly of claim 6, wherein said communications device is a universal asynchronous receiver/transmitter.

8. The actuator assembly of claim 1, wherein said memory includes a test profile byte and a redundant test profile byte, said processor confirming validity of the test profile byte and the redundant test profile byte prior to initiating said test mode.

9. The actuator assembly of claim 1, wherein said processor includes a test input pin, said processor confirming a state of said test input pin prior to initiating said test mode.

10. The actuator assembly of claim 1, wherein said memory includes a test enable bit, said processor confirming a state of said test enable bit prior to initiating said test mode.

11. The actuator assembly of claim 1, wherein said memory includes a test profile byte and a redundant test profile byte, said processor confirming validity of the test profile byte and the redundant test profile byte prior to initiating said test mode;
wherein said processor includes a test input pin, said processor confirming a state of said test input pin prior to initiating said test mode; and,
wherein said memory includes a test enable bit, said processor confirming a state of said test enable bit prior to initiating said test mode.
